(19) United States
(12) Patent Application Publication
(10) Pub. No.: US 2006/0026185 A1
(43) Pub. Date: Feb. 2, 2006

(54) Systems and methods for compression of frame-based data

(76) Inventor: Scott D. Lykken, North Bend, WA (US)

Correspondence Address: TIMOTHY C. CARLSON;HONEYWELL INTERNATIONAL INC., Law Dept. AB2, 101 Columbia Road, Morristown, NJ, 07962, US

(21) Appl. No.: 10/890,944

(22) Filed: Jul. 13, 2004

(51) Int. Cl. G06F 7/00

(52) U.S. Cl. 707/101

(57) ABSTRACT

Methods, systems, and computer program products for compressing a data file that includes a plurality of frames, wherein each frame includes a plurality of data words. An example computer based system retrieves data from corresponding data word locations in the plurality of frames in the original data file, stores the retrieved data words sequentially in a second data file, and compresses the second data file. The system creates the original data file by retrieving data from a plurality of sources and storing the retrieved data into corresponding data word locations within frames of the original data file. The second data file is stored on a removable storage device, such as a PCMCIA card, or is transmitted to a remote computer system.

### FIELD OF THE INVENTION

This invention relates to data compression, and more particularly, to frame-based data compression.

### BACKGROUND OF THE INVENTION

In certain data acquisition applications, data is stored and recorded in a frame-based model (i.e., frame data file). The frame data file includes a plurality of frames, each frame including separately identifiable data words. Each data word represents a different aspect of the acquired data. For example, in a commercial aircraft application, flight data and system information is retrieved and stored for later analysis by maintenance personnel. The data acquired is of various categories and is presently stored in a frame-based model. In the frame-based model, a frame of information includes data stored as 12 or 16 bit words that identify different flight data, such as altitude, air speed, etc. Each word position within a frame is reserved for a particular parameter of the flight data.

Presently, the flight data file is stored in a removable memory device, such as a PCMCIA card. Because storage space is premium on PCMCIA cards and the amount of data retrieved during a flight is voluminous, there is a need for compressing the flight data file. Present compression techniques can provide a 4 to 1 compression ratio. As diagnostic requirements increase, there is a greater need for more and more data to be retrieved from an aircraft. Thus, more and more data would be needed to be inserted into a flight data file, thereby, increasing the need for better compression schemes.

Therefore, there exists a need to further compress data stored in frame-based models, such as flight data files.

### SUMMARY OF THE INVENTION

The present invention provides methods, systems, and computer program products for compressing a data file that includes a plurality of frames, wherein each frame includes a plurality of data words. An example computer based system retrieves data from corresponding data word locations in the plurality of frames in the original data file, stores the retrieved data words sequentially in a second data file, and compresses the second data file.

In accordance with further aspects of the invention, the system creates the original data file by retrieving data from a plurality of sources and storing the retrieved data into corresponding data word locations within frames of the original data file.

In accordance with other aspects of the invention, the system includes a removable storage device that stores the second data file. The removable storage device is a PCMCIA card, compact flash cards, or any comparable removable storage card.

In accordance with still further aspects of the invention, the system includes a wireless data transmission system coupled to the processor for transmitting the second data file to a remote computer system.

In accordance with yet other aspects of the invention, the system is implemented on an aircraft. The original data file is a flight data file.

### BRIEF DESCRIPTION OF THE DRAWINGS

The preferred and alternative embodiments of the present invention are described in detail below with reference to the following drawings.

FIG. 1 is a block diagram of an exemplary system formed in accordance with the present invention;

FIG. 2A illustrates a process for compressing frame data files based on an embodiment of the present invention;

FIG. 2B illustrates a process for decompressing frame data files based on an embodiment of the present invention;

FIG. 3A illustrates an exemplary frame data file prior to being prepared for compression; and

FIG. 3B illustrates the frame data file of FIG. 3A that has been reformatted or reorganized and optimized for compression.

### DETAILED DESCRIPTION OF THE INVENTION

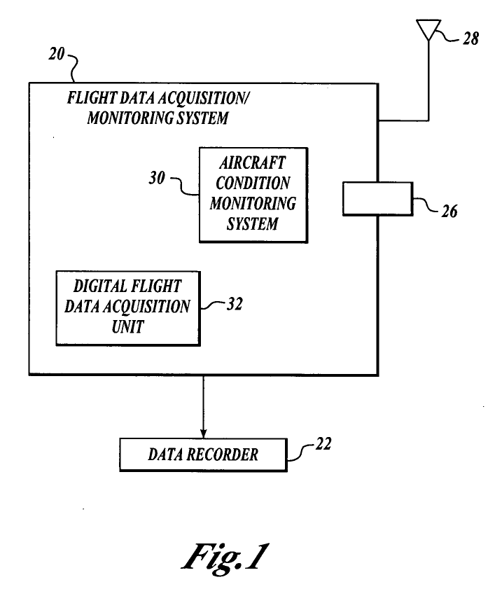

FIG. 1 illustrates a vehicle 10, such as an aircraft, having a flight data acquisition and recording system 15 formed in accordance with an embodiment of the present invention. The system 15 includes a flight data acquisition and management system 20 that is in data communication with a flight data recorder 22. The flight data acquisition and management system 20 receives data for other aircraft systems and stores the data according to a frame-based model. The data is recorded on the flight data recorder 22. The flight data acquisition and management system 20 reorganizes the received or stored data and compresses the data prior to transmission to a receiving system via an antenna 28 or storage on a removable storage device 26.

In one embodiment, the flight data acquisition and management system 20 includes a digital flight data acquisition unit (DFDAU) 32 and an aircraft condition monitoring system (ACMS) 30. The DFDAU 32 continually receives data from various aircraft systems or retrieves data from a databus, such as an ARINC-429 bus. The DFDAU 32 places the data into a frame file having multiple frames with each having multiple bit words. It can be appreciated that the bit words can be of any size, such as 12 or 16 bit words, depending upon what information they represent. The DFDAU 32 sends the frame file to the ACMS 30. The ACMS 30 reorganizes the frame file for compression, compresses the reorganized frame file, and sends the compressed data to one of the memory device 26 or the antenna 28.

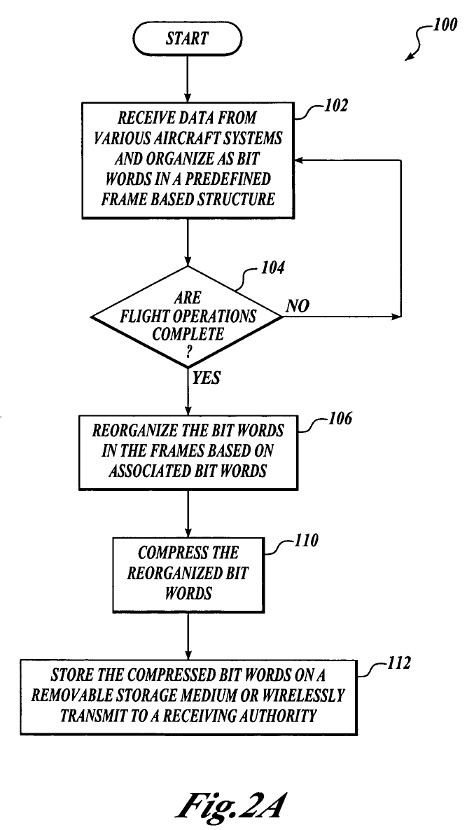

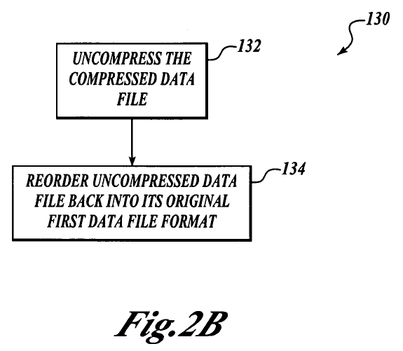

As shown in FIG. 2A, an exemplary process 100 is shown for performing the process of compressing retrieved flight data for storage to the removal memory device 26 or transmission via the antenna 28 using any of a number of data transmission protocols, such as 802.11, Bluetooth, IR, etc. Examples of the removal memory device 26 include PCMCIA cards, compact flash cards, or any comparable removable storage card. The process 100 begins at a block 102 where data is received by the DFDAU 32 from various aircraft systems. The DFDAU 32 stores the received data into a first frame data file having frames with bit word positions within the frames. The data is stored based on where the data came from or what the data represents. Next, at a decision block 104, the process 100 repeats the block 102 at a predefined frequency if it is determined that flight operations are not complete or flight data acquisition is still needed. If flight data acquisition is complete, data no longer needs to be acquired, or some other trigger event has occurred (such as any type of automatic or manual selections), then the DFDAU 32 sends the first frame data file to the ACMS 30 or informs the ACMS 30 that the first frame data file is ready for compression.

In one embodiment, the DFDAU 32 creates the frame content and sends the data words to the recorder as a stream of data. The DFDAU 32 also sends the data words to the ACMS 30.

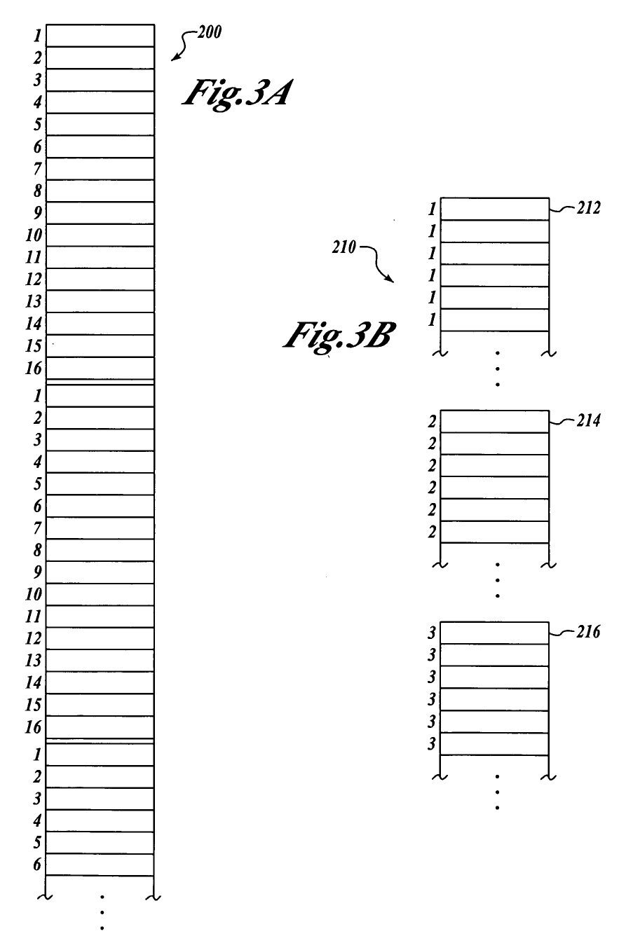

At a block 106, the ACMS 30 parses all the frames of data that were collected and generates a second data file that is optimized for compression based on the parsing. This is described in more detail by example in FIGS. 3A and 3B. After the second data file has been created, then, at a block 110, the second data file is compressed based on any number of standard compression schemes, such as Gzip or Winzip®. At a block 112, the compressed data file is then either stored on the removable data memory device 26 or is wirelessly transmitted to a receiving authority via the antenna 28. An example receiving authority might be a computer system operated by the owner or operator of the vehicle. In one embodiment, a wireless network system (e.g., cellular phone system, Bluetooth, 802.11, etc.) is included for delivering the wirelessly transmitted compressed data file to the receiving authority.

FIG. 2B illustrates a process 130 for uncompressing the compressed data file stored on the removable data memory device 26 or wirelessly transmitted. First, at a block 132, the compressed data file is uncompressed using the uncompression version of the compression scheme used to compress the second data file. The uncompressed data file is reorder back into its original first data file format.

FIG. 3A illustrates a portion of a first data file 200 that is created upon retrieval of differently categorized data, see the block 102 of FIG. 2. In this example, the first data file 200 includes a plurality of frames, wherein each frame includes sixteen data words. Each data word identifies a different piece of retrieved data. For example, if the vehicle 10 is an aircraft, a data word in row 1 might store a word that identifies the aircraft's altitude, and a data word in row 2 might indicate the aircraft's angle of attack. Because different pieces of data are stored sequentially in each data file (e.g., 5500 feet, 220 kts, 20° pitch, etc.), compression of all the data in the data file 200 is limited by the differences between adjacent data.

It can be appreciated that multiple data words may be associated with the same piece of data.

As shown in FIG. 3B, the ACMS 30 has created a second data file 210 that has been optimized for compression. The ACMS 30 counts the number of frames, preferably complete frames, in the first data file 200 then parses out the data words from each corresponding row of the frames and stores them in the second data file 210. In one embodiment, the second data file includes sections that are equal to the number of complete frames. The second data file 210 shows that the ACMS 30 has retrieved all the data words from row 1 for each frame in the first data file 200 and stored them sequentially in a first section 212 of the second data file 210. The same has occurred for data words in rows 2 (section 214), 3 (section 216), and so on.

Because much of the flight data in the second data file 210 does not vary significantly over short periods of time, compressing the flight data when like data is stored next to like data (e.g., airspeed data is placed next to airspeed data) is more effective. In some examples, compression ratios of 8:1 or better are achieved.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method of compressing a first data file including a plurality of frames, wherein each frame includes a plurality of data words, the method comprising:
retrieving data from corresponding data word locations in the plurality of frames in the first data file;
storing the retrieved data words sequentially in a second data file; and
compressing the second data file.

2. The method of claim 1, further comprising:
determining the number of complete frames of data in the first data file,
wherein storing is further based on the determined number of complete frames of data.

3. The method of claim 1, wherein the first data file includes data retrieved from a plurality of sources and stored into corresponding data word locations within frames of the first data file.

4. The method of claim 1, further comprising:
storing the second data file on a removable storage device.

5. The method of claim 1, further comprising:
wirelessly transmitting the second data file to a computer system.

6. The method of claim 1, further comprising:
performing retrieving, storing, compressing, and determining on a computer system within a vehicle.

7. The method of claim 6, wherein the vehicle is an aircraft and the first data file is a flight data file.

8. The method of claim 7, further comprising:
determining if a trigger event has occurred, wherein the trigger event includes at least one of end of operation of the aircraft or end of data retrieval,
wherein retrieving data if it was determined that a trigger event has occurred.

9. The method of claim 1, further comprising:
uncompressing the compressed data file; and
reordering the uncompressed data file into the same format as the first data file.

10. A computer program product for compressing a first data file including a plurality of frames, wherein each frame includes a plurality of data words, the product comprising:
a first component for retrieving data from corresponding data word locations in the plurality of frames in the first data file;
a second component for storing the retrieved data words sequentially in a second data file; and
a third component for compressing the second data file.

11. The product of claim 10, further comprising:
a fourth component for determining the number of complete frames of data in the first data file,
wherein the second component is based on the determined number of complete frames of data.

12. The product of claim 10, wherein the first data file includes data retrieved from a plurality of sources and stored into corresponding data word locations within frames of the first data file.

13. The product of claim 10, further comprising:
a fourth component for storing the second data file on a removable storage device.

14. The product of claim 10, further comprising:
a fourth component for wirelessly transmitting the second data file to a computer system.

15. A computer-based system for compressing a predetermined first data file, the first data file includes a plurality of frames, wherein each frame includes a plurality of data words, the system comprising:
a processor comprising:
a first component for retrieving data from corresponding data word locations in the plurality of frames in the first data file;
a second component for storing the retrieved data words sequentially in a second data file; and
a third component for compressing the second data file.

16. The system of claim 15, wherein the processor further comprises:
a fourth component for determining the number of complete frames of data in the first data file,
wherein the second component stores further based on the determined number of complete frames of data.

17. The system of claim 15, wherein the processor further comprises:
a fourth component for creating the first data file by retrieving data from a plurality of sources and storing the retrieved data into corresponding data word locations within frames of the first data file.

18. The system of claim 15, further comprising:
a removable storage device coupled to the processor,
wherein the processor further comprises a fourth component for storing the second data file on the removable storage device.

19. The system of claim 18, wherein the removable storage device is a PCMCIA card.

20. The system of claim 15, further comprising:
a wireless data transmission system coupled to the processor,
wherein the processor further comprises a fourth component for wirelessly transmitting the second data file to a computer system via the wireless data transmission system.

21. The system of claim 15, wherein the system is implemented on an aircraft.

22. The system of claim 21, wherein the first data file is a flight data file.

23. A system on an aircraft, the system comprising:
a databus coupled to one or more flight data systems, the databus configured to communicate a plurality of flight data;
a processor comprising:
a first component for retrieving at least a portion of the plurality of flight data from the databus;
a second component for creating a first data file by inserting the retrieved flight data into corresponding data word locations in frames based on time;
a third component for retrieving data from corresponding data word locations in the plurality of frames of the first data file;
a fourth component for storing the retrieved data words sequentially in a second data file; and
a fifth component for compressing the second data file; and
a removable storage device coupled to the processor for storing the compressed second data file.

24. The system of claim 23, wherein the removable storage device is a PCMCIA card.

25. A system on an aircraft, the system comprising:
a databus coupled to one or more flight data systems, the databus configured to store a plurality of flight data previously generated by one or more aircraft systems;
a processor comprising:
a first component for retrieving a portion of the plurality of flight data from the databus;
a second component for creating a first data file by inserting the retrieved flight data into corresponding data word locations in frames based on time;
a third component for retrieving data from corresponding data word locations in the plurality of frames in the first data file;
a fourth component for storing the retrieved data words sequentially in a second data file; and
a fifth component for compressing the second data file; and
a data transmitter coupled to the processor for transmitting the second data file to a computer system remote from the aircraft.
